(19) United States
(12) Patent Application Publication
(10) Pub. No.: US 2025/0100800 A1
(43) Pub. Date: Mar. 27, 2025

(54) Picking System

(71) Applicant: Daifuku Co., Ltd., Osaka-shi (JP)

(72) Inventors: Takashi Ukon, Osaka-shi (JP); Masaya Miyamoto, Tokyo (JP); Erika Imura, Tokyo (JP)

(21) Appl. No.: 18/897,030

(22) Filed: Sep. 26, 2024

(30) Foreign Application Priority Data
Sep. 27, 2023 (JP) 2023-166395

(51) Int. Cl. B65G 1/137; G06Q 10/087

(52) U.S. Cl. CPC B65G 1/1373; G06Q 10/087

(57) ABSTRACT

In a picking system, a control system performs a batch generation process of collecting a predetermined number of pieces of the order information and setting picking operations corresponding to the collected pieces of the order information as a single batch operation. In the batch generation process, if the control system is able to set a target batch operation number to less than or equal to a deliverable total number, the control system collects the predetermined number of pieces of order information such that the target batch operation number is less than or equal to the deliverable total number, and if the control system is unable to set the target batch operation number to less than or equal to the deliverable total number, the control system performs a deliverable total number increase process of increasing the deliverable total number.

### CROSS-REFERENCE TO RELATED APPLICATION

This application claims priority to Japanese Patent Application No. 2023-166395 filed Sep. 27, 2023, the disclosure of which is hereby incorporated by reference in its entirety.

### BACKGROUND OF THE INVENTION

### 1. Field of the Invention

The present invention relates to a picking system including an automatic warehouse storing a plurality of placement bodies, each of which includes a plurality of articles, a plurality of operation areas where a picking operation is performed to pick out the articles of a type and number designated by order information from among the placement bodies taken out from the automatic warehouse, based on the order information for designating the type and number of articles required for each shipping destination, a transport system that transports the placement bodies between the automatic warehouse and the plurality of operation areas, and a control system that controls the automatic warehouse and the transport system.

### 2. Description of the Related Art

In a picking system used in a distribution center or the like, a placement body on which articles of the type designated by order information are placed is transported from an automatic warehouse to an operation area. In the operation area, a picking operation is performed to pick out the articles of the type and number designated by order information. In the picking system, a plurality of picking operations generated as tasks are assigned to each of a plurality of operation areas. An example of such a picking system is disclosed in Japanese Patent Application Laid-Open No. 2015-199562.

### SUMMARY OF THE INVENTION

Meanwhile, the type of articles stored in an automatic warehouse of a picking system are diverse, and needs (for example, shipping frequency and shipping quantity) also vary depending on the type of articles. It is common to perform inventory management in the automatic warehouse according to needs, but the needs for articles can change according to a change in a market environment. For example, when a need arises that exceeds an originally anticipated demand, the supply of articles from the automatic warehouse to an operation area may be delayed, and sometimes a picking operation is not performed smoothly in the operation area.

In view of the above-described situation, there is a desire to realize a picking system capable of increasing efficiency of a picking operation.

A picking system according to the present disclosure includes an automatic warehouse including a plurality of placement bodies, each configured to receive a plurality of articles, a plurality of operation areas where a picking operation is performed to pick out the articles of a type and number designated by order information from a placement body taken out from the automatic warehouse, based on the order information for designating the type and number of the articles required for each shipping destination, a transport system configured to transport the placement bodies between the automatic warehouse and the plurality of operation areas, and a control system configured to control the automatic warehouse and the transport system, in which the control system is further configured to perform a batch generation process of collecting a predetermined number of pieces of the order information and setting picking operations corresponding to the collected pieces of the order information as a single batch operation, an operation assignment process of assigning each of a plurality of batch operations generated in the batch generation process to one of the plurality of operation areas, and a transport process of transporting, to the one of the plurality of operation areas, a placement body required for the batch operations assigned by the operation assignment process to each of the plurality of operation areas, each of a plurality of types is set as a target type, a placement body in which an article of the target type is placed is set as a target placement body, a total number of the target placement body that is able to be taken out from the automatic warehouse is set as a deliverable total number, the number of a first batch operation in which an article of the target type is included in a target of the picking operation is set as a target batch operation number, and in the batch generation process, if the control system is able to set the target batch operation number to less than or equal to the deliverable total number, the control system collects the predetermined number of pieces of the order information such that the target batch operation number is less than or equal to the deliverable total number, and if the control system is unable to set the target batch operation number to less than or equal to the deliverable total number, the control system performs a deliverable total number increase process of increasing the deliverable total number.

According to the present configuration, in the batch generation process, when a target batch operation number which is the number of batch operations in which articles of a target type are included in a target of a picking operation is able to be less than or equal to a deliverable total number, order information including the articles of the target type is collected such that the target batch operation number is less than or equal to the deliverable total number. Thereby, it is possible to avoid that the number of target placement bodies is insufficient with respect to the number of operation areas where a picking operation for target articles is performed. Therefore, it is possible to suppress the occurrence of operation wait that waits for a target placement body required for a picking operation in an operation area. In addition, according to the present configuration, in a batch generation process, when a target batch operation number that is the number of batch operations in which articles of a target type are included in a target of a picking operation is not able to be less than or equal to a deliverable total number, a deliverable total number increase process of increasing the deliverable total number is performed. Thereby, the deliverable total number is able to be increased according to the number of operation areas where the picking operation for the target articles is performed, and thus, it is possible to avoid that the number of target placement bodies is insufficient with respect to the number of operation areas where a picking operation for target articles is performed. Therefore, even in this case, it is possible to suppress occurrence of operation wait. As described above, according to the present configuration, it is possible to increase efficiency of a picking operation.

Further features and advantages of the technique according to the present disclosure will become clearer from following description of exemplary and non-limiting embodiments made with reference to the accompanying drawings.

### BRIEF DESCRIPTION OF THE DRAWINGS

FIG. 1 is a plan view of a picking system;

FIG. 2 is a control block diagram of the picking system;

FIG. 3 is an explanatory diagram of a picking operation;

FIG. 4 is an explanatory diagram of a batch operation;

FIG. 5 is a diagram illustrating an example of the order number for each type of article;

FIG. 6 is an explanatory diagram of calculation of an overlapping risk index; and

FIG. 7 is an explanatory diagram of a deliverable total number increase process.

### DESCRIPTION OF THE INVENTION

Hereinafter, an embodiment of the picking system will be described with reference to the drawings.

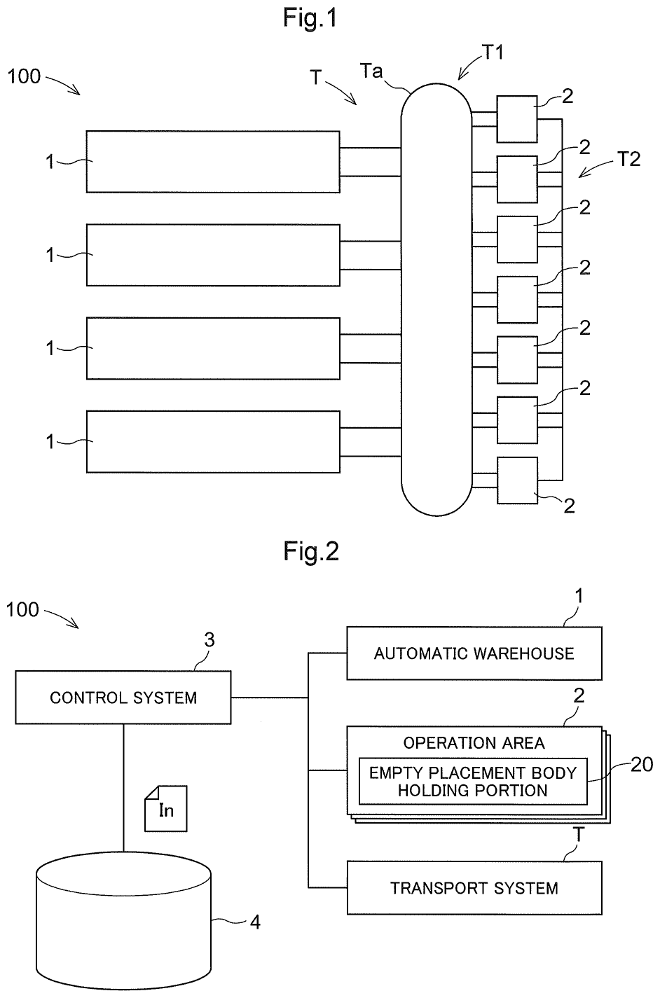

As illustrated in FIGS. 1 to 3, a picking system 100 includes an automatic warehouse 1 that stores a plurality of placement bodies 5, in each of which a plurality of articles W are placed, a plurality of operation areas 2 where a picking operation is performed to pick out articles W of the type and number designated by order information In, based on the order information In for designating the type and number of articles W required for each shipping destination, from the placement bodies 5 taken out from the automatic warehouse 1, a transport system T for transporting the plurality of placement bodies 5 between the automatic warehouse 1 and the plurality of operation areas 2, and a control system 3 that controls the automatic warehouse 1 and a transport system T.

The articles W include industrial products, daily necessities, food products, and the like. In addition, the articles W may include completed products or semi-completed products. The articles W are stored in the automatic warehouse 1 while placed on the placement bodies 5 and are transported to each location by the transport system T.

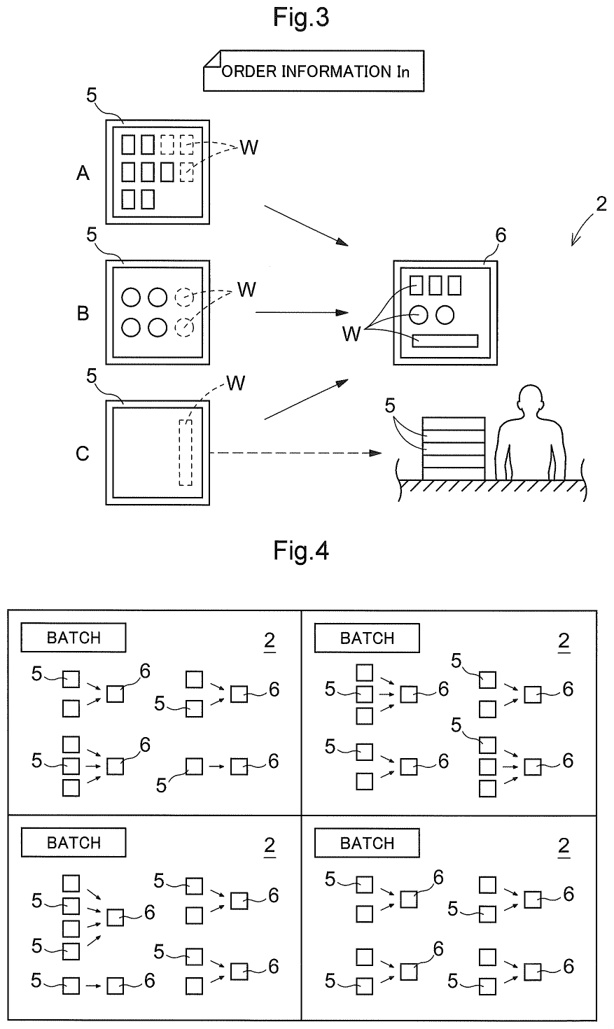

The placement body 5 includes a container or a pallet. In addition, the container includes a folding container or a corrugated cardboard box. In the present embodiment, the placement body 5 is configured with a storage container to be stored in the automatic warehouse 1 (see FIG. 3). In the present example, a single type of article W is placed on one placement body 5. However, a plurality of types of articles W may be placed on the one placement body 5.

Although detailed description is omitted, the automatic warehouse 1 includes a storage shelf for storing the placement body 5 and an in-shelf transport device for transporting the placement body 5 within the automatic warehouse 1. The in-shelf transport device is able to include, for example, a stacker crane, a lifter, a transport cart disposed on each level of a storage shelf, and a conveyor, or the like. The in-shelf transport device forms a part of the transport system T. In the present embodiment, the picking system 100 includes a plurality of automatic warehouses 1. When the automatic warehouse 1 includes a conveyor as the in-shelf transport device, the placement body 5 may be configured to be stored on the conveyor. In this case, the automatic warehouse 1 is also able to be configured without a stacker crane or a transport cart.

In the present embodiment, the transport system T includes a conveyor Ta. A transport path of the placement body 5 by the conveyor Ta is formed to connect the plurality of automatic warehouses 1 to the plurality of operation areas 2. The placement body 5, which is taken out from any of the plurality of automatic warehouses 1, is transported to any of the plurality of operation areas 2 through the transport path of the conveyor Ta. The placement body 5, from which the necessary article W is picked out by a picking operation in the operation area 2, is transported to any of the plurality of automatic warehouses 1 through the transport path of the conveyor Ta and stored therein. The transport system T may include another type of transport device, such as an unmanned transport vehicle, either instead of the conveyor Ta or in addition to the conveyor Ta. As described above, the transport system T includes an in-shelf transport device that transports the placement body 5 within the automatic warehouse 1.

In the present embodiment, the transport system T includes a first transport path T1, through which the placement body 5 is transported, between the automatic warehouse 1 and the plurality of operation areas 2, and in addition to the first transport path T1, a second transport path T2, through which the placement body 5 is transported, is included between the plurality of operation areas 2.

The second transport path T2 is a path that is not connect to the respective automatic warehouses 1. In the present example, the second transport path T2 is a path that connects only the plurality of operation areas 2 to each other. The second transport path T2 is a path used for a direct transport process that does not pass through the automatic warehouse 1, as will be described below.

As illustrated in FIG. 2, the control system 3 is configured to control the automatic warehouse 1, the operation area 2, and the transport system T, based on the order information In. In addition, the control system 3 also controls an operation instruction output device (such as a monitor), a picking robot, or so on disposed in the operation area 2.

The order information In is information for designating the type and number of articles W required for each shipping destination. The order information In is information generated based on customer needs and is stored in a server 4. The control system 3 acquires the order information In from the server 4.

The control system 3 is configured to perform inventory management of the articles W in the automatic warehouse 1. The control system 3 is configured to manage at least the type and number of articles W placed on each placement body 5 stored in the automatic warehouse 1.

The control system 3 selects one or more placement bodies 5 required for a picking operation in each operation area 2 based on the order information In, and transports the selected placement bodies 5 to respective operation areas 2 by using the transport system T. The transportation of the placement body 5 from the automatic warehouse 1 to the operation area 2 is performed through the above-described first transport path T1.

The control system 3 is able to be configured with a plurality of hardware components or a plurality of software components. The control system 3 includes, for example, a processor such as a microcomputer, a peripheral circuit such as a memory, and the like. Each function is performed by cooperation of the hardware and a program executed on a processor such as a computer.

Next, a picking operation performed in the operation area 2 will be described.

As illustrated in FIG. 3, the picking operation is performed based on the order information In. A single or a plurality of articles W designated by the order information In are collected in the picking operation. For example, the order information In is generated for each shipping destination. Therefore, the picking operation is referred to as an operation of collecting the articles W required for each shipping destination.

A single or a plurality of placement bodies 5, in which articles W of the type and number designated by the order information In are placed, are transported to a specific operation area 2, and in the picking operation, the articles W related to the order information In are picked out and collected in a shipping container 6.

When all the articles W placed on the placement body 5 are picked out by the picking operation, the placement body 5 becomes empty. In the present embodiment, the operation area 2 is provided with an empty placement body holding portion 20 that holds the empty placement body 5 generated by the picking operation. Thereby, the empty placement body 5 can be stored in the operation area 2. When the placement body 5 is configured with a folding container, by stacking the plurality of placement bodies 5 in a folded state, a space is able to be efficiently utilized. As will be described below, in the present example, the empty placement body 5 stored in the operation area 2 is used in a placement body division operation.

In the example illustrated in FIG. 3, by the order information In, three articles W (hereinafter referred to as an “article A”) of type A are designated, two articles W (hereinafter referred to as an “article B”) of type B are designated, and one article W (hereinafter referred to as an “article C”) of type C is designated. In the present example, each placement body 5 is configured to place the article W of a single type, and the placement body 5 in which three or more articles A are placed, the placement body 5 in which two or more articles B are placed, and the placement body 5 in which one or more articles C are placed are transported to the operation area 2. In the picking operation in the operation area 2, three articles A, two articles B, and one article C are collected in the shipping container 6. The picking operation may be performed by an operator or may be performed in an unmanned manner by a picking robot or the like. Alternatively, the picking operation may be performed by both an operator and a picking robot.

In FIG. 3, the articles C (one article C in the illustrated example) of the same number as the number designated by the order information In are placed on the placement body 5 that transports the article C. Therefore, when a picking operation is performed on the placement body 5, the placement body 5 becomes empty and is held by the empty placement body holding portion 20.

As illustrated in FIG. 4, the control system 3 (see FIG. 2) is configured to perform a batch generation process of collecting order information In of a set number (predetermined number) and setting a picking operation corresponding to the collected order information In as one batch operation, an operation assignment process of assigning each of a plurality of batch operations generated in the batch generation process to one of the plurality of operation areas 2, and a transport process of transporting the placement body 5 required for the batch operation assigned in the operation assignment process to each of the plurality of operation areas 2.

The batch operation includes a picking operation related to the order information In of a set number. That is, the batch operation includes picking operations of a set number. In the present embodiment, the “set number” refers to the maximum number of picking operations that are able to be included in one batch operation. In the present example, the set number is set to 4. That is, in this case, the number of picking operations that are able to be included in one batch operation is set to 1 to 4. However, the set number may not be “4” and may be, for example, “1”. As described above, in the present embodiment, the set number is a fixed value but may also be a value that changes depending on situations.

In the example illustrated in FIG. 4, four batch operations are illustrated. Each of the four batch operations includes four picking operations. Each of the four batch operations is assigned to one of the four operation areas 2 by an operation assignment process. However, as described above, the number of picking operations included in one batch operation may not exceed the set number and may be 1 to 3 in the present example.

Here, the type of articles W stored in the automatic warehouse 1 of the picking system 100 are diverse, and the needs also change depending on the type of articles W.

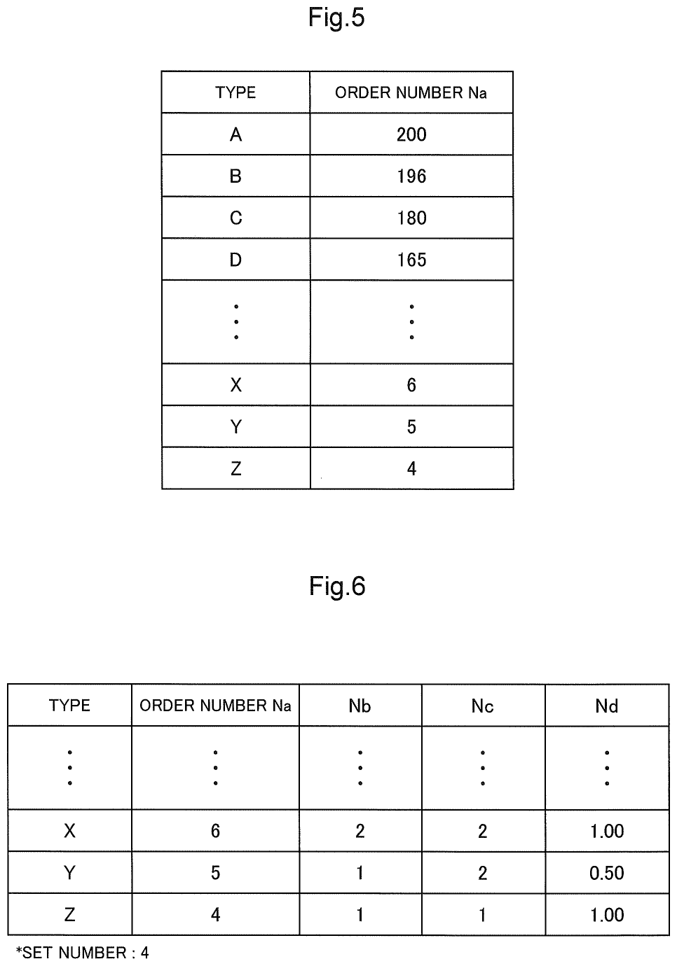

For example, as illustrated in FIG. 5, it is assumed that the type of articles W ranges from A to Z. A right column of the table indicates an order number Na for each type of articles W. The order number Na indicates the number of specific types of articles W involved in the order information In to be processed within a unit period. In the illustrated example, type A is included in each of 200 pieces of order information In. In other words, the articles W of type A are required in the picking operation associated with each of the 200 pieces of order information In. The order numbers Na of types X, Y, and Z are relatively small, and the order numbers Na are respectively “6”, “5”, and “4”.

The picking system 100 performs inventory management in the automatic warehouse 1. In the inventory management, the inventory number of articles W of a type with high demand, which tends to have a relatively large order number Na, is increased (that is, the number of articles W to be stored in the automatic warehouse 1 is increased), while the inventory number of articles W of a type with low demand, which tends to have a relatively small order number Na, is decreased. As a result, the storage efficiency of the article W in the automatic warehouse 1 can be easily improved.

Here, each of the plurality of types is set as a target type, the placement body 5 in which the article W of a target type is placed is set as a target placement body 5, the total number of the target placement bodies 5 that are able to be taken out from the automatic warehouse 1 is set as a deliverable total number Nb, and the number of batch operations in which the article W of a target type is included as a target of the picking operation is set as a target batch operation number Nc. The deliverable total number Nb is, for example, the total number of target placement bodies 5 currently stored in the automatic warehouse 1. The target batch operation number Nc is, for example, the number of batch operations required to process all orders for designating the article W of a target type. The “target type” refers to part or all of the types that are targets of the batch generation process or the deliverable total number increase process to be described below among all types handled by the picking system 100.

FIG. 6 illustrates the deliverable total number Nb, the target batch operation number Nc, and an overlapping risk index Nd (described below) for each type of articles W, particularly for types X, Y, and Z having a relatively small order number Na. In the present embodiment, since the set number is “4”, one batch operation includes four picking operations (the order information In). The target batch operation number Nc is a value obtained by dividing the order number Na by the set number (in the present example, “4”). When the value obtained by the division includes a decimal point, a fraction process is performed on the divided value to obtain a value rounded up below the decimal point, and thus, the number of batch operations required to handle all orders for designating the articles W of a target type is obtained. In a configuration where one batch operation is performed in one operation area 2, the target batch operation number Nc is able to be rephrased as the number of operation areas 2 where batch operations are performed.

As described above, the inventory number of the articles W with low needs and a tendency in which the order number Na is relatively small is small. Accordingly, in the example illustrated in FIG. 6, the deliverable total number Nb of the target placement bodies 5 in which the articles W of type X are placed is “2”, the deliverable total number Nb of the target placement bodies 5 in which the articles W of type Y are placed is “1”, and the deliverable total number Nb of the target placement bodies 5 in which the articles W of type Z are placed is “1”.

The order number Na for designating the articles W of type X is “6”. The target batch operation number Nc, that is, the number of batch operations required to handle six orders is “2” which is obtained by rounding up to the nearest whole number a value (1.5) obtained by dividing the order number Na “6” by the set number “4”. That is, in the present embodiment where the set number is “4”, two operation areas 2 are required to simultaneously handle six orders. In the articles W of type X, the deliverable total number Nb is “2”, and thus, the placement body 5 in which the articles W of type X are placed is able to be provided to each of the two operation areas 2.

The order number Na for designating the articles W of type Y is “5”. The target batch operation number Nc, that is, the number of batch operations required to handle five orders is “2” which is obtained by rounding up to the nearest whole number a value (1.25) obtained by dividing the order number Na “5” by the set number “4”. That is, in the present embodiment where the set number is “4”, two operation areas 2 are required to simultaneously handle five orders. In the articles W of type Y, the deliverable total number Nb is “1”, and thus, the placement body 5 in which the articles W of type Y are placed is not able to be provided to each of the two operation areas 2. Therefore, in either of the two operation areas 2, an operation wait occurs for the target placement body 5 (herein, the placement body 5 in which the articles W of type Y are placed) required for the picking operation.

The order number Na for designating the articles W of type Z is “4”. The target batch operation number Nc, that is, the number of batch operations required to handle four orders is “1” which is obtained by dividing the order number Na “4” by the set number “4”. That is, in the present embodiment where the set number is “4”, one operation area 2 is required to simultaneously handle four orders. In the articles W of type Z, the deliverable total number Nb is “1”, and thus, the placement body 5 in which the articles W of type Z are placed is able to be provided to the one operation area 2.

As described above, in the present example, the articles W of type Y have an insufficient number of target placement bodies 5 for the number of operation areas 2 where the picking operation for the articles W of type Y is performed (a situation in which operation wait is able to occur).

The control system 3 is configured to increase or decrease the target batch operation number Nc by changing the number of pieces of order information In (hereinafter referred to as an “order collection number”) to be collected within a range not exceeding the set number. The target batch operation number Nc is calculated by dividing the order number Na by the order collection number, like as Equation (1).

Target batch operation number Nc=order number Na/order collection number (1)
The order collection number is a value less than or equal to the set number.

Therefore, as the order collection number increases, the target batch operation number Nc decreases, and as the order collection number decreases, the target batch operation number Nc increases. The control system 3 is able to set an appropriate target batch operation number Nc with respect to the deliverable total number Nb by controlling the increase or decrease of the target batch operation number Nc.

In the batch generation process, when the target batch operation number Nc is able to be set to be less than or equal to the deliverable total number Nb, the control system 3 collects the order information In such that the target batch operation number Nc is less than or equal to the deliverable total number Nb. In other words, the control system 3 sets the order collection number such that the target batch operation number Nc is less than or equal to the deliverable total number Nb. Thereby, it is possible to suppress the occurrence of operation wait in the operation area 2. A case in which the target batch operation number Nc is able to be set to be less than or equal to the deliverable total number Nb refers to a case in which the target batch operation number Nc is able to be set to be less than or equal to the deliverable total number Nb by increasing the order collection number to limitation of the set number and by decreasing the target batch operation number Nc.

In the batch generation process, when the target batch operation number Nc is not able to be less than or equal to the deliverable total number Nb, the control system 3 performs a deliverable total number increase process of increasing the deliverable total number Nb. That is, by setting the order collection number to the set number that is a maximum number of the order information In which is able to be collected, even when the target batch operation number Nc is set to a minimum number, when the target batch operation number Nc exceeds the deliverable total number Nb, the control system 3 performs the deliverable total number increase process. For example, in the present example, the target batch operation number Nc that is able to be a minimum number for five order number for the articles W of type Y is “2” which is greater than the deliverable total number Nb (herein, “1”). In such a case, as described above, the target placement body 5 that is able to be provided is insufficient for the number of operation areas 2 where the picking operation of the articles W of type Y is performed, and thereby, operation wait occurs.

In the present embodiment, the control system 3 performs an index calculation process of calculating, for all types, the overlapping risk index Nd, indicating a likelihood (level of possibility) of the number of target placement bodies 5 being insufficient relative to the number of operation areas 2 where a picking operation of the article W of a target type is performed. A type in which the overlapping risk index Nd is less than a predetermined determination threshold is set as an overlapping risk type, and the control system 3 performs a batch generation process for the order information In for designating the overlapping risk type and also performs the deliverable total number increase process for the target placement body 5 in which the articles W of the overlapping risk type are placed.

The overlapping risk index Nd is calculated by dividing the deliverable total number Nb by the target batch operation number Nc. In the present example, the determination threshold is “1.0”.

In the example illustrated in FIG. 6, the overlapping risk index Nd for type Y is “0.5” which is less than the determination threshold. Therefore, type Y becomes the overlapping risk type. The control system 3 is able to provide an appropriate number of the target placement bodies 5 corresponding to the target batch operation number Nc by performing the deliverable total number increase process for the target placement bodies 5 in which the articles W of the overlapping risk type are placed.

In addition, in the present embodiment, when the target batch operation number Nc is not able to be set to be less than or equal to the deliverable total number Nb in the batch generation process, the control system 3 collects the order information In to minimize the target batch operation number Nc, and then performs the deliverable total number increase process. Thereby, even when the deliverable total number increase process is performed, it is possible to suppress the degree of increase in the deliverable total number Nb to be reduced.

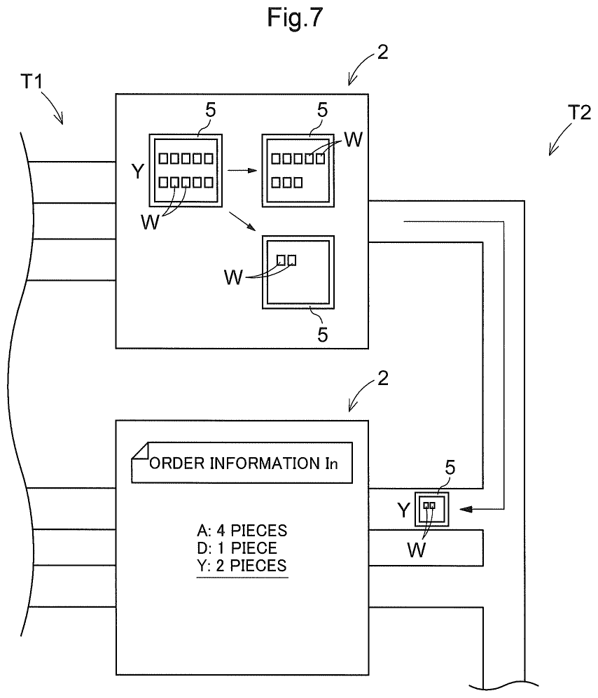

As illustrated in FIG. 7, in the present embodiment, the deliverable total number increase process includes a placement body division operation that is an operation of dividing the plurality of articles W of a target type placed on one target placement body 5 and placing the divided articles W in the plurality of placement bodies 5.

In the present embodiment, the placement body division operation is performed in any one of the plurality of operation areas 2. The control system 3 designates one of the plurality of operation areas 2 and issues an instruction to either an operator or a picking robot that performs an operation in the designated operation area 2. For example, the control system 3 issues an instruction to the operator by using an operation instruction output device (such as a monitor) provided in the operation area 2. An instruction signal for the picking robot is transmitted to a control device that controls the picking robot. Hereinafter, the operation area 2 where the placement body division operation is performed is referred to as a “target operation area 2”. The target operation area 2 is one of the operation areas 2 where a batch operation is performed in which the articles W of a target type (in the present embodiment, an overlapping risk type) are included in a target of the picking operation.

As described above, in the target operation area 2, the empty placement body 5 generated by the picking operation is held by an empty placement body holding portion 20. In the placement body division operation, the plurality of articles W of the target type placed on the target placement body 5 are distributed into the empty placement body 5 held by the empty placement body holding portion 20.

In the example illustrated in FIG. 7, in addition to the target operation area 2 where the picking operation for the articles W of type Y, which is the overlapping risk type, is performed, there is another operation area 2 where the picking operation for the articles W of type Y. In the target operation area 2 where the target placement body 5 in which the articles W of type Y are placed is provided, the placement body division operation is performed, and some of the plurality of articles W placed on the target placement body 5 are transferred to the empty placement body 5 held in the target operation area 2. Thereby, the placement body 5 in which the articles W of type Y, for which the deliverable total number Nb is “1”, are placed is increased to two placement bodies.

In the present embodiment, after the placement body division operation is completed in the target operation area 2, the control system 3 controls the transport system T to transport at least one of the placement bodies 5, in which the articles W of the target type are placed, through the second transport path T2, to the operation area 2, other than the target operation area 2, where the batch operation is performed in which the articles W of the target type are included in the target of the picking operation. The control system 3 performs a direct transport process in which the placement body 5 is transported between different operation areas 2 without passing through the automatic warehouse 1, thereby transporting the placement body 5 generated in the placement body division operation through the second transport path T2. The article W placed on the placement body 5 (target placement body 5) generated in the placement body division operation is the article W placed on the target placement body 5 delivered from the automatic warehouse 1, and the target placement body 5 generated in the placement body division operation is also able to be used in the operation area 2 in the same manner as the target placement body 5 delivered from the automatic warehouse 1. Therefore, increasing the total number of the target placement bodies 5 that are able to be used in the operation area 2 through the placement body division operation is equivalent to increasing the deliverable total number Nb that is the total number of the target placement bodies 5 which are able to be delivered from the automatic warehouse 1. The total number of the target placement bodies 5 that are able to be used in the operation area 2 is able to be regarded as the deliverable total number Nb.

In the example illustrated in FIG. 7, one of two placement bodies 5 in which the articles W of type Y are placed is transported from the target operation area 2 to another operation area 2 through the second transport path T2.

In the present embodiment, in the placement body division operation, the required number of articles W of a target type in another operation area 2, other than the target operation area 2, is transferred to the placement body 5 which is transported to another operation area 2.

In the example illustrated in FIG. 7, in another operation area 2, other than the target operation area 2 where the picking operation for the articles W of type Y is performed, two articles W of type Y are designated by the order information In. That is, the required number of articles W of type Y in another operation area 2 is “2”. Accordingly, in the placement body division operation performed in the target operation area 2, two articles W are transferred from the target placement body 5, in which ten articles W of type Y are placed, to an empty placement body 5. The placement body 5, in which two articles W of type Y are placed, is transported from the target operation area 2 to another operation area 2 through the second transport path T2. With such a configuration, it is possible to perform a picking operation for the articles W of type Y simultaneously in both the target operation area 2 and another operation area 2.

In the present embodiment, a picking operation for the articles W of a target type is performed in the target operation area 2 after the placement body division operation is performed. In the example illustrated in FIG. 7, the picking operation is performed in the target operation area 2 by using eight articles W placed on the target placement body 5 after the placement body division operation. Thereby, the articles W of the target type are able to be provided to another operation area 2 at an earlier stage.

In the picking system 100 according to the present disclosure, a plurality of pieces of order information In for designating the articles W of at least the overlapping risk type are collected in one batch by using the algorithm described above. The order information In for designating the articles W of a type other than the overlapping risk type may be collected in one batch by using another algorithm according to, for example, a shipping frequency or the like.

### Other Embodiments

Next, other embodiments will be described.

(1) In the above-described embodiment, an example is provided in which, in the placement body division operation, the empty placement body 5 held by the empty placement body holding portion 20 in the target operation area 2 where the operation is performed is used. However, the present disclosure is not limited to such an example, and the empty placement body 5 used for the placement body division operation may be transported to the target operation area 2 from a location (for example, an empty space or the like in the automatic warehouse 1) that is different from the target operation area 2. In this case, in order to perform a placement body division operation in the target operation area 2 that is one of the operation areas 2 where a batch operation is performed in which the articles W of a target type are included in a target of a picking operation, the control system 3 controls the automatic warehouse 1 and the transport system T such that the target placement body 5 and the placement body 5 in which the articles W are not placed are transported to the target operation area 2.

(2) In the above-described embodiment, an example is described in which the deliverable total number Nb is increased in the placement body division operation. However, the present disclosure is not limited to such an example, and the deliverable total number Nb may be increased by replenishing the automatic warehouse 1 with the target placement body 5, in which the articles W of a target type are placed, from a location (for example, a sub-warehouse) that is different from the automatic warehouse 1.

(3) In the above-described embodiment, an example is described in which, in the placement body division operation performed in the target operation area 2, some of the plurality of articles W placed on the target placement body 5 is transferred to the empty placement body 5 held in the target operation area 2. However, the present disclosure is not limited to such an example, and the placement body division operation may be performed by transferring all of the articles W placed on the target placement body 5 to a plurality of empty placement bodies 5 in a distributed manner.

(4) In the above-described embodiment, an example is described in which a placement body division operation is performed in any one of the plurality of operation areas 2. However, the present disclosure is not limited to such an example, and the placement body division operation may be performed in an area (for example, a dedicated area for the placement body division operation) provided separately from the operation area 2 where a picking operation is performed.

(5) In the above-described embodiment, an example is described in which a picking operation for the articles W of a target type is performed in the target operation area 2 after a placement body division operation is performed. However, the present disclosure is not limited to such an example, and the placement body division operation may be performed by using the remained number of articles W after the picking operation is performed.

(6) In the above-described embodiment, an example is described in which the control system 3 performs a direct transport process of transporting the placement body 5 between different operation areas 2 without passing through the automatic warehouse 1, thereby transporting the placement body 5 generated in the placement body division operation through the second transport path T2. However, the present disclosure is not limited to such an example, and the control system 3 may transport the placement body 5 generated in the placement body division operation through the first transport path T1 through the automatic warehouse 1 and may transport the placement body 5 to another operation area 2.

(7) In the above-described embodiment, an example is described in which a determination threshold of the overlapping risk index Nd is set to “1.0”. However, the present disclosure is not limited to such an example, and the determination threshold may be set to be less than “1.0”. In this case, when the overlapping risk index Nd is greater than or equal to the determination threshold and less than 1, the target batch operation number Nc exceeds the deliverable total number Nb, and a deliverable total number increase process is not performed, and thus, all target batch operations (batch operations in which the articles W of a target type are included in a target of a picking operation) are not able to be simultaneously performed, but by performing the target batch operations at a different time, all target batch operations can be completed. However, even in this case, the determination threshold may be set to “0.5”, preferably a value greater than “0.5” such that the time required to complete all the target batch operations is not increased significantly. According to this, the degree of insufficiency of the deliverable total number Nb for the target batch operation number Nc is able to be minimized, the time required to complete all the target batch operations is able to be easily minimized.

(8) A configuration disclosed in the above-described embodiment is able to be combined with a configuration disclosed in another embodiment and applied thereto, as long as no contradictions arise. Regarding other configurations, the embodiments disclosed in the present specification are merely examples in all respects. Therefore, various modifications are able to be made as appropriate within the scope of the present disclosure.

### Summary of the Present Embodiment

Hereinafter, a summary of the present embodiment will be described.

A picking system includes an automatic warehouse including a plurality of placement bodies, each configured to receive a plurality of articles, a plurality of operation areas where a picking operation is performed to pick out the articles of a type and number designated by order information from a placement body taken out from the automatic warehouse, based on the order information for designating the type and number of the articles required for each shipping destination, a transport system configured to transport the placement bodies between the automatic warehouse and the plurality of operation areas, and a control system configured to control the automatic warehouse and the transport system, in which the control system is further configured to perform a batch generation process of collecting a predetermined number of pieces of the order information and setting picking operations corresponding to the collected pieces of the order information as a single batch operation, an operation assignment process of assigning each of a plurality of batch operations generated in the batch generation process to one of the plurality of operation areas, and a transport process of transporting, to the one of the plurality of operation areas, a placement body required for the batch operations assigned by the operation assignment process to each of the plurality of operation areas, each of a plurality of types is set as a target type, a placement body in which an article of the target type is placed is set as a target placement body, a total number of the target placement body that is able to be taken out from the automatic warehouse is set as a deliverable total number, the number of a first batch operation in which an article of the target type is included in a target of the picking operation is set as a target batch operation number, and in the batch generation process, if the control system is able to set the target batch operation number to less than or equal to the deliverable total number, the control system collects the predetermined number of pieces of the order information such that the target batch operation number is less than or equal to the deliverable total number, and if the control system is unable to set the target batch operation number to less than or equal to the deliverable total number, the control system performs a deliverable total number increase process of increasing the deliverable total number.

According to the present configuration, in the batch generation process, when a target batch operation number which is the number of batch operations in which articles of a target type are included in a target of a picking operation is able to be less than or equal to a deliverable total number, order information including the articles of the target type is collected such that the target batch operation number is less than or equal to the deliverable total number. Thereby, it is possible to avoid that the number of target placement bodies is insufficient with respect to the number of operation areas where a picking operation for target articles is performed. Therefore, it is possible to suppress the occurrence of operation wait that waits for a target placement body required for a picking operation in an operation area. In addition, according to the present configuration, in a batch generation process, when a target batch operation number that is the number of batch operations in which articles of a target type are included in a target of a picking operation is not able to be less than or equal to a deliverable total number, a deliverable total number increase process of increasing the deliverable total number is performed. Thereby, the deliverable total number is able to be increased according to the number of operation areas where the picking operation for the target articles is performed, and thus, it is possible to avoid that the number of target placement bodies is insufficient with respect to the number of operation areas where a picking operation for target articles is performed. Therefore, even in this case, it is possible to suppress occurrence of operation wait. As described above, according to the present configuration, it is possible to increase efficiency of a picking operation.

It is preferable that, in the batch generation process, if the control system is unable to set the target batch operation number to less than or equal to the deliverable total number, the control system collects the predetermined number of pieces of the order information such that the target batch operation number is minimized, and then performs the deliverable total number increase process.

According to the present configuration, the order information is collected to minimize the target batch operation number in the batch generation process, and thus, it is possible to suppress the degree of increase in deliverable total number even when performing the deliverable total number increase process.

It is preferable that the deliverable total number increase process includes a placement body division operation of distributing a plurality of articles of the target type placed on a target placement body to a plurality of placement bodies, and to perform the placement body distributing operation in a target operation area as one of a plurality of operation areas for the first batch operation, the control system controls the automatic warehouse and the transport system to transport to the target operation area the target placement body and one or more placement bodies in each of which no article is placed.

According to the present configuration, the number of placement bodies in which target articles are placed is able to be increased by performing a placement body division operation and distributing the target articles to a plurality of placement bodies. Therefore, even when a new target placement body is not added to an automatic warehouse, a deliverable total number is able to be increased. In addition, according to the present configuration, such a placement body division operation is able to be performed by using an operation area where a picking operation of a target articles is performed, and thus, it is possible to reduce necessity of transporting a target placement body solely for the placement body division operation and to reduce necessity of adding a new operation area or equipment.

It is preferable that the transport system includes a first transport path for transporting the placement bodies between the automatic warehouse and the plurality of operation areas; and a second transport path for transporting the placement bodies between the plurality of operation areas, and after the placement body division operation is completed in the target operation area, the control system controls the transport system to transport at least one of the placement bodies, in which an article of the target type is placed, through the second transport path to a first operation area among the plurality of operation areas for the first batch operation which first operation area is other than the target operation area.

According to the present configuration, after a placement body division operation is performed, a placement body in which a target article is placed is able to be transported to another operation area that requires the target article without returning to an automatic warehouse. Therefore, transport efficiency of a placement body is able to be increased, and occurrence of operation wait in other operation areas is able to be easily minimized.

It is preferable that, the placement body division operation includes transferring a required number of an article of the target type in an operation area other than the target operation area to a placement body to be transported to the operation area other than the target operation area.

According to the present configuration, it is possible to prevent a placement body, in which articles of fraction are placed, from occurring after an operation in an operation area other than a target operation area is completed. Therefore, the capacity of an automatic warehouse is less likely to be squeezed, and it is easy to eliminate the need for combining the articles placed on multiple placement bodies into one placement body.

It is preferable that the control system performs an index calculation process of calculating, for all types, an overlapping risk index indicating a likelihood of the number of a target placement body being insufficient relative to the number of operation areas where a picking operation for an article of the target type is performed, and the control system performs the batch generation process for order information for designating an overlapping risk type as a type of which the overlapping risk index is lower than a predetermined determination threshold, and performs the deliverable total number increase process for a target placement body in which an article of the overlapping risk type is placed.

According to the present configuration, by collecting order information for designating an overlapping risk type, the number of operation areas where a picking operation for articles of the overlapping risk type, which is a type with a less deliverable total number than the order number, is performed is able to be set to be less than or equal to a deliverable total number. In addition, even when the number of operation areas where a picking operation for articles of an overlapping risk type is performed is not able to be less than or equal to a deliverable total number, a deliverable total number increase process is performed, and thereby, the deliverable total number is able to be increased. Accordingly, it is possible to reduce the possibility that an operation wait occurs in an operation area where a picking operation for articles of an overlapping risk type is performed.

### INDUSTRIAL APPLICABILITY

Technology according to the present disclosure is able to be used for a picking system.

What is claimed is:

1. A picking system comprising:
an automatic warehouse comprising a plurality of placement bodies, each configured to receive a plurality of articles;
a plurality of operation areas where a picking operation is performed to pick out the articles of a type and number designated by order information from a placement body taken out from the automatic warehouse, based on the order information for designating the type and number of the articles required for each shipping destination;
a transport system configured to transport the placement bodies between the automatic warehouse and the plurality of operation areas; and
a control system configured to control the automatic warehouse and the transport system, and
wherein:
the control system is further configured to perform a batch generation process of collecting a predetermined number of pieces of the order information and setting picking operations corresponding to the collected pieces of the order information as a single batch operation, an operation assignment process of assigning each of a plurality of batch operations generated in the batch generation process to one of the plurality of operation areas, and a transport process of transporting, to the one of the plurality of operation areas, a placement body required for the batch operations assigned by the operation assignment process to each of the plurality of operation areas,
each of a plurality of types is set as a target type,
a placement body in which an article of the target type is placed is set as a target placement body,
a total number of the target placement body that is able to be taken out from the automatic warehouse is set as a deliverable total number,
the number of a first batch operation in which an article of the target type is included in a target of the picking operation is set as a target batch operation number, and
in the batch generation process, if the control system is able to set the target batch operation number to less than or equal to the deliverable total number, the control system collects the predetermined number of pieces of the order information such that the target batch operation number is less than or equal to the deliverable total number, and if the control system is unable to set the target batch operation number to less than or equal to the deliverable total number, the control system performs a deliverable total number increase process of increasing the deliverable total number.

2. The picking system according to claim 1, wherein:
in the batch generation process, if the control system is unable to set the target batch operation number to less than or equal to the deliverable total number, the control system collects the predetermined number of pieces of the order information such that the target batch operation number is minimized, and then performs the deliverable total number increase process.

3. The picking system according to claim 1, wherein:
the deliverable total number increase process comprises a placement body division operation of distributing a plurality of articles of the target type placed on a target placement body to a plurality of placement bodies, and
to perform the placement body distributing operation in a target operation area as one of a plurality of operation areas for the first batch operation, the control system controls the automatic warehouse and the transport system to transport to the target operation area the target placement body and one or more placement bodies in each of which no article is placed.

4. The picking system according to claim 3, wherein:
the transport system comprises a first transport path for transporting the placement bodies between the automatic warehouse and the plurality of operation areas; and a second transport path for transporting the placement bodies between the plurality of operation areas, and
after the placement body division operation is completed in the target operation area, the control system controls the transport system to transport at least one of the placement bodies, in which an article of the target type is placed, through the second transport path to a first operation area among the plurality of operation areas for the first batch operation which first operation area is other than the target operation area.

5. The picking system according to claim 3, wherein:
the placement body division operation comprises transferring a required number of an article of the target type in an operation area other than the target operation area to a placement body to be transported to the operation area other than the target operation area.

6. The picking system according to claim 1, wherein:
the control system performs an index calculation process of calculating, for all types, an overlapping risk index indicating a likelihood of the number of a target placement body being insufficient relative to the number of operation areas where a picking operation for an article of the target type is performed, and
the control system performs the batch generation process for order information for designating an overlapping risk type as a type of which the overlapping risk index is lower than a predetermined determination threshold, and performs the deliverable total number increase process for a target placement body in which an article of the overlapping risk type is placed.
